(19) United States
(12) Patent Application Publication
(10) Pub. No.: US 2012/0164902 A1
(43) Pub. Date: Jun. 28, 2012

(54) COMPRESSED SHEET

(76) Inventors: Dietrich Wienke, Elsloo (NL); Martinus Johannes Nicolaas Jacobs, Heerlen (NL); Roelof Marissen, Born (NL); Johannes Gabriël Drieman, Heerlen (NL); van Eelco Oosterbosch, Tilburg (NL)

(21) Appl. No.: 13/265,166

(22) PCT Filed: Apr. 22, 2010
(86) PCT No.: PCT/EP2010/055337

§ 371 Date: Jan. 9, 2012

(30) Foreign Application Priority Data
Apr. 23, 2009 (EP) 09158621.4

(51) Int. Cl. D03D 15/00; B29C 43/22; D04H 13/00

(52) U.S. Cl. 442/181; 442/327; 264/103

(57) ABSTRACT

The invention relates to a compressed sheet comprising at least one woven or non-woven fabric, said fabric comprising polymeric fibers, characterized in that the sheet has a bending modulus of at least 15 GPa when measured according to ASTM D790-07 in at least two directions and wherein one of said directions is the orientation direction of a first majority of the fibers contained by said fabric. The invention also relates to a method of manufacturing such compressed sheets and to articles comprising thereof.

The invention relates to a compressed sheet comprising at least one woven or non-woven fabric, said fabric comprising polymeric fibers. The invention further relates to a method for manufacturing thereof and to various articles comprising said compressed sheet.

A compressed sheet is known for example from GB 2,253,420. This publication discloses compressed polymeric monoliths and in particular planar sheets which can be produced by heating an assembly of polymeric fibers under a contact pressure to a temperature at which a proportion of the fiber is selectively melted and then further compressing the assembly at yet even higher pressures. GB 2,253,420 also discloses compressed planar sheets made by compressing woven mats of melt spun high modulus polyethylene fibers or by compressing unidirectional sheets containing uniaxially aligned polyethylene fibers.

It was observed that the mechanical properties of the compressed sheets obtained with the process of GB 2,253,420 can be further improved. Investigations showed that the compressed unidirectional sheets of GB 2,253,420 although having good mechanical properties in one direction, e.g. a longitudinal direction, possessed poor mechanical properties in a second direction, e.g. a transverse, direction thereof.

An attempt was made to improve the transversal properties of the sheet of GB 2,253,420 by compressing together a stack of unidirectional sheets wherein the uniaxially aligned fibers in a sheet run at an angle, usually 90°, with respect to the running (or orientation) direction of fibers in an adjacent sheet. However, it was observed that in this case both the longitudinal mechanical properties as well as the transversal mechanical properties were reduced to an unacceptable lower level.

A further attempt was made to improve said transversal properties by compressing woven mats. It was however observed that the obtained sheets have unsatisfactorily longitudinal as well as transversal mechanical properties. Furthermore, it was also observed that all compressed sheets of GB 2,253,420 as well as other known compressed sheets exhibit a large bending deflection even when subjected to a relatively low bending force.

In order to diversify the utility of known compressed sheets and in particular their utility as construction materials, the mechanical properties of said sheets must be further improved and in particular, said sheets should exhibit improved properties in more than one direction.

An aim of the present invention may for example be to provide a compressed sheet having suitable mechanical properties, and in particular having a suitable bending modulus in at least two directions. A further aim of the present invention may be to provide a compressed sheet having an increased resistance against bending and/or buckling and being suitable for use as a stand alone construction material.

The invention provides a compressed sheet comprising at least one woven or non-woven fabric, said fabric comprising polymeric fibers, characterized in that the sheet has a bending modulus of at least 15 GPa when measured according to ASTM D790-07 in at least two directions and wherein one of said directions is the orientation direction of a first majority of the fibers contained by said at least one woven or non-woven fabric.

It was observed that the sheet of the invention has improved mechanical properties and in particular it has an increased bending modulus in more than one direction which to inventors' knowledge was never achieved hitherto. The sheet of the invention was also surprisingly lightweight and could be handled with greater ease. For simplicity and unless otherwise stated, the bending modulus measured in at least two directions will be referred hereinafter to as the 2D bending modulus.

It was furthermore surprisingly observed that the sheet of the invention, also referred to as the inventive sheet, was able to support its own weight without experiencing substantial bending and/or buckling when placed in a horizontal position on two supporting means positioned at both ends of the sheet while the part therein between remained unsupported. Such an increased resistance to bending and/or buckling was also surprisingly achieved for large sized sheets of the invention, i.e. sheets with more than a meter long length (L) and width (W).

Preferably, the inventive sheet is a planar sheet, i.e. the whole sheet is contained in a plane defined by the length L and the width W of the sheet or if the sheet has a disk-like shape, the plane of the disk. For such a sheet, the directions along which the 2D bending modulus is measured are contained in the plane of the sheet.

The inventive sheet may also be curved in one or more directions. For a curved sheet, the 2D bending modulus is measured along a first direction which is both tangent and along to the orientation direction of a first majority of the fibers contained by said fabric. The second direction is preferably the direction tangent and along to the orientation direction of a second majority of the fibers contained by said fabric.

The inventive sheet may also contain local areas that are raised or lowered with respect to the surrounding area, e.g. bumps or indentations. The 2D bending modulus for a sheet containing said local areas is measured by choosing a location on the sheet that is planar and measuring the bending modulus in at least two directions on that planar location.

Preferably the 2D bending modulus of the sheet of the invention is at least 20 GPa, more preferably at least 30 GPa, even more preferably, at least 35 GPa, most preferably at least 40 GPa as measured according to ASTM D790-07. The measurements on 2D bending modulus were carried out on samples extracted from the sheet of the invention by cutting, the cutting being performed with a high pressure water jet to ensure smooth edges of the sample, said samples preferably having a length (l) over thickness (d) ratio (l/d) of about 24. Preferably, the thickness of the sample is between 1.75 and 1.95. The length (l) of the extracted samples was cut along the direction of measurement. The skilled person can produce sheets having such high 2D bending modulus according to a process as detailed hereinafter.

The sheet of the invention preferably has a 2D flexural strength, i.e. the flexural strength measured in two directions, of at least 50 MPa, more preferably at least 80 MPa, most preferably at least 100 MPa as determined by ASTM D790-07 on a sample having a length (l) over thickness (d) ratio (l/d) of 24. Preferably, the thickness of the sample is between 1.75 and 1.95.

According to the invention, the 2D bending modulus is measured in at least two directions one of which being along the orientation direction of a first majority of the fibers contained by said fabric. An orientation direction of a majority of fibers is herein understood a common orientation direction of preferably at least 10 mass % of the fibers contained by the fabric, more preferably at least 30 mass %, most preferably at least 50 mass %. By mass % is herein understood the percentage of the fibers oriented in a common direction, said percentage being computed from the total mass of fibers oriented in all possible direction and being contained by the fabric. Said orientation direction can be determined for example by visually inspecting the fibers or with the aid of a microscope. For both cases of the woven and the non-woven fabric, the skilled person knows how to determine said direction.

Woven fabrics generally contain at least two sets of yarns that are interlaced and lie at an angle to each other. A woven fabric can be characterized in most cases by a length L and a width W after being produced, wherein the term ‘after being produced’ is herein understood the fabric immediately after its production, e.g. before being cut or trimmed or otherwise processed after its production, In such a case, the fibers that run along the length L of the fabric are known as warps or warp ends while the fibers that run along or at an angle to the width W of the fabric are known as wefts or weft picks. In the case of woven fabrics the skilled person can immediately determine that a first majority of the fibers contained by said fabric may be the majority of fibers comprising the warps, while e.g. a second majority of the fibers may be the majority of fibers comprising the wefts. The skilled person can also immediately determine the orientation direction of the warps or of the wefts and he can use for example any of these directions as one of the orientation directions of a first majority of the fibers contained by said fabric.

Preferred embodiments of woven fabrics include plain (tabby) weaves, basket weaves, twill weaves, crow feet weaves and satin weaves although more elaborate weaves such as triaxial weaves may also be used. Preferably, the woven fabric is a basket weave, a plain weave or a twill weave.

In one embodiment of the invention, the fibers used to manufacture the woven fabric have a rounded cross-section, said cross section having an aspect ratio of at most 4:1, more preferably at most 2:1, and said fabric having a cover factor of at least 1.5, more preferably at least 2, most preferably at least 3. Preferably said cover factor is at most 10, more preferably at most 8, most preferably at most 6. It was observed that by using woven fabrics with a lower cover factors the 2D bending modulus may be improved. It was also observed that the sheets manufactured from such fabrics may have an increased homogeneity. However, handling of fabrics with a too low cover factor becomes difficult as such fabrics are sensitive to fiber shifts and thus to local variations in the final products' mechanical properties.

In another embodiment of the invention, the woven fabric contained by the inventive sheet is a tridimensional (3D) woven fabric. It is known in the art how to produce such fabrics, for example from EP 0.548.517, U.S. Pat. No. 6,627,562 and WO 02/07961. In a preferred embodiment the 3D woven fabric is a layered fabric comprising at least 2 layers, more preferably at least 3 layers. It was observed that in addition to an increase in the 2D bending modulus, a sheet containing such fabric may be less prone to delamination when subjected to bending forces.

Non-woven fabrics within the meaning of the present invention are fabrics produced by bonding and/or interlocking of fibers accomplished by e.g. inherent fiber-to-fiber friction (entanglement), mechanical, chemical, thermal or by solvent means and combinations thereof. The term non-woven fabric within the meaning of the present invention does not include fabrics that are woven, knitted or tufted.

Preferred embodiments of non-woven fabrics include various constrained or unconstrained arrangements of fibers including substantially parallel arrays, layered arrays with each layer having substantially parallel fibers and adjacent arrays being non-parallel to each other. A non-woven fabric may also be a fabric comprising one or more layers containing randomly oriented staple or continuous fibers. When the fabric contains substantially parallel arrays, the fibers direction in any of the arrays can be used as one of the orientation directions of a first majority of the fibers contained by said fabric. When the fabric contains randomly oriented fibers, any direction can be chosen as one of the orientation directions of a first majority of the fibers contained by said fabric.

The areal density (AD) of the fabric contained in the sheet of the invention can vary within wide ranges. Preferably, the AD of said fabric is at least 100 g/m². Other suitable ADs of said fabric may be at least 300 g/m², or event at least 500 g/m². The upper limit for said AD is only dictated by practical reasons and is chosen by the skilled person with regard to the application for which the manufactured inventive sheet is intended. It is however preferred that said fabric has a lower AD since a lighter sheet of the invention can be obtained having also a suitable 2D bending modulus.

If the fabric is a woven fabric, the areal density of the woven fabric is preferably between 100 and 2000 g/m². Other preferred ADs for such a woven fabric may be between 200 and 1000 g/m² or even between 300 and 800 g/m². It was observed that for such areal densities an inventive sheet containing woven fabrics possessed an increased 2D bending modulus and was also lightweight.

Preferably, the sheet of the invention contains at least 2 fabrics, more preferably at least 4 fabrics, most preferably at least 6 fabrics, said fabrics being preferably stacked such that they overlap over substantially their whole surface area. Alternatively, the inventive sheet can contain a single piece of fabric folded over itself at least 2 times, more preferably at least 4 times, most preferably at least 6 times, all folds having preferably the same length (L) and width (W). It was observed that sheets containing an increased number of fabrics showed further improved 2D bending modulus as well as an increased resistance to impacts with various fast moving objects, e.g. shrapnel or bullets, or slow moving objects, e.g. the forks of a forklift truck.

When at least two fabrics are used to manufacture the inventive sheet, the fabrics may be arranged such that the orientation direction of a first majority of fibers in a fabric is under an angle of between 0 and 90° with respect to the orientation direction of a first majority of fibers in an adjacent fabric, more preferably said angle being between 30 and 90°, most preferably between 45 and 90°. When the fabric used to construct the inventive sheet is a woven fabric, preferably, the orientation direction of the warp fibers in a fabric is at an angle of between 30 and 90°, most preferably of between 45 and 90° with the orientation direction of the warp fibers in an adjacent fabric. When the fabrics used to construct the inventive sheet are non-woven, said non-woven fabrics are preferably layered fabrics comprising at least one layer, said layer comprising two monolayers wherein the monolayers comprise unidirectionally oriented fibers and wherein the monolayers are orientated at an angle with respect to each other of between 15 and 90°, more preferably of between 30 and 90°, most preferably of between 45 and 90°. Methods of manufacturing such layered non-woven fibers are disclosed for example in WO 02/057527; EP 0,768,167; DE 197,07,125; DE-A-23,20,133. It was observed that for embodiments where adjacent fabrics in an inventive sheet were rotated with respect to each other, sheets shows a high 2D bending modulus in a multitude of directions may be obtained and furthermore, the resistance to buckling and/or bending and in particular to directional buckling and/or bending of said sheets may be further improved. A further advantage may be that such an inventive sheet shows improved impact energy resistance and in particular a reduced deformation upon an impact.

The fabrics and in particular the non-woven fabrics may also contain a binder, also known as matrix, which is usually locally applied to stabilize the polymeric fibers within the fabric such that the structure of the fabric is retained during handling. Said binders may also be used to promote adhesion between the fabrics when more than two fabrics are used to construct the inventive sheet.

Suitable binders are described in e.g. EP 0,191,306; EP 1,170,925; EP 0,683, 374; WO 2009/008922 and EP 1,144,740 and include Polyethylene-P0440 1, Polyethylene-P04605 10, Polyethylene-D0 184B, Polyurethane-D0 187H, and Polyethylene-D0188Q, which are all available from Spunfab, Ltd. of Cayahoga Falls, Ohio; Kraton D1 161 P, which is available from Kraton Polymers U.S., LLC of Houston, Tex.; Macromelt 6900, which is available from Henkel Adhesives of Elgin, Ill.; and Noveon-Estane 5703, which is available from Lubrizol Advanced Materials, Inc. of Cleveland, Ohio. The amount of the binder is preferably at most 20 wt %, more preferably at most 10 wt %, most preferably at most 5 wt %.

In a preferred embodiment the fabric used to manufacture the inventive sheet is a woven fabric, said woven fabric being binder- or matrix-free. It was observed that binder- or matrix-free sheets manufactured by compressing binder- or matrix-free woven fabrics may have an increased 2D bending modulus. It was also observed that such sheets manufactured from such fabrics may have an increased homogeneity of their mechanical properties and in particular of their 2D bending modulus. It was also observed that delamination may be reduced in particular when basket weave woven fabrics were used. It was furthermore observed that the variation of the 2D bending modulus when measured at different locations on the surface of such sheets may be decreased.

Preferably, the inventive sheet is a sheet having a length (L) and a width (W), wherein L and/or W are at least 0.5 m, more preferably at least 1 m, most preferably at least 1.5 m. More preferably, both L and W are at least 0.5 m, more preferably at least 1 m. The upper limits for L and W are dictated by the application for which the inventive sheet is intended. Preferably, the length L and/or the width W of the inventive sheet are at most 5 meter, more preferably at most 4 meters, most preferably at most 3 meters. Such large sized sheets, also known as panels, are more advantageous as construction materials because they can be easier and more rapidly installed and furthermore they are more efficient to produce. The invention thus also relates to a panel or to a large sized inventive sheet. An advantage of the panels of the invention may be that these panels have good resistance against bending and/or buckling.

The sheet may also comprise various conventional additives and reinforcing agents to further enhance various characteristics of said sheet. For example the sheet may further contain additives e.g. pigments, antioxidants, UV stabilizers and delusterants in an amount of preferably from 1 to 15 mass %, more preferably from 2 to 5 mass % from the total mass of the sheet of the invention.

The thickness of the sheet of the invention can vary within wide ranges and is dictated by the initial thickness, i.e. the thickness before compressing, of the fabric contained in said sheet and/or by the number of said fabrics and/or by the processing conditions, e.g. pressure and time.

Examples of polymeric fibers include but are not limited to fibers manufactured from polyamides and polyaramides, e.g. poly(p-phenylene terephthalamide) (known as Kevler®); poly(tetrafluoroethylene) (PTFE); poly{2,6-diimidazo-[4,5b-4′,5′e]pyridinylene-1,4(2,5-dihydroxy)phenylene} (known as M5); poly(p-phenylene-2, 6-benzobisoxazole) (PBO) (known as Zylon®); poly(hexamethyleneadipamide) (known as nylon 6,6), poly(4-aminobutyric acid) (known as nylon 6); polyesters, e.g. poly(ethylene terephthalate), poly(butylene terephthalate), and poly(1,4 cyclohexylidene dimethylene terephthalate); polyvinyl alcohols; thermotropic liquid crystal polymers (LCP) as known from e.g. U.S. Pat. No. 4,384,016; but also polyolefins e.g. homopolymers and copolymers of polyethylene and/or polypropylene. Also combinations of fibers manufactured from the above referred polymers can be used to manufacture the fabric contained in the inventive sheet. Preferred fibers are polyolefin fibers, polyamide fibers and LCP fibers.

By fiber is herein understood an elongated body, the length dimension of which is much greater that the transverse dimensions of width and thickness. The term fiber also includes various embodiments e.g. a filament, a ribbon, a strip, a band, a tape and the like having regular or irregular cross-sections. The fibers may have continuous lengths, known in the art as filaments, or discontinuous lengths, known in the art as staple fibers. Staple fibers are commonly obtained by cutting or stretch-breaking filaments. A yarn for the purpose of the invention is an elongated body containing many fibers.

Very good results were obtained when the polymeric fibers are polyolefin fibers, more preferably polyethylene fibers. Preferred polyethylene fibers are ultrahigh molecular weight polyethylene (UHMWPE) fibers. Said polyethylene fibers may be manufactured by any technique known in the art, preferably by a melt or a gel spinning process. Most preferred fibers are gel spun UHMWPE fibers, e.g. those sold by DSM Dyneema under the name Dyneema®. If a melt spinning process is used, the polyethylene starting material used for manufacturing thereof preferably has a weight-average molecular weight between 20,000 and 600,000, more preferably between 60,000 and 200,000. An example of a melt spinning process is disclosed in EP 1,350,868 incorporated herein by reference. If the gel spinning process is used to manufacture said fibers, preferably an UHMWPE is used with an intrinsic viscosity (IV) of preferably at least 3 dl/g, more preferably at least 4 dl/g, most preferably at least 5 dl/g. Preferably the IV is at most 40 dl/g, more preferably at most 25 dl/g, more preferably at most 15 dl/g. Preferably, the UHMWPE has less than 1 side chain per 100 C atoms, more preferably less than 1 side chain per 300 C atoms. Preferably the UHMWPE fibers are manufactured according to a gel spinning process as described in numerous publications, including EP 0205960 A, EP 0213208 A1, U.S. Pat. No. 4,413,110, GB 2042414 A, GB-A-2051667, EP 0200547 B1, EP 0472114 B1, WO 01/73173 A1, EP 1,699,954 and in “Advanced Fibre Spinning Technology”, Ed. T. Nakajima, Woodhead Publ. Ltd (1994), ISBN 185573 182 7.

In a preferred embodiment, at least 80 mass %, more preferably at least 90 mass %, most preferably 100 mass % of the fibers in the fabric or fabrics used to manufacture the inventive sheet are polyethylene fibers and more preferably UHMWPE fibers. It was observed that by using fabrics containing polyethylene fibers to manufacture the inventive sheet, said sheet may show in addition to a suitable 2D bending modulus, good resistance to sun light and UV degradation.

In an especially preferred embodiment of the present invention, the fiber has a length much larger than its width and thickness and a width larger than its thickness, i.e. said fiber being a tape. The tape is preferably derived from polyolefin, more preferably from UHMWPE. A tape (or a flat tape) for the purposes of the present invention is a fiber having a cross sectional aspect ratio of at least 5:1, more preferably at least 20:1, even more preferably at least 100:1 and yet even more preferably at least 1000:1. By cross sectional aspect ratio is herein understood the ratio between the largest distance between two points on the perimeter of the cross section of the tape, hereinafter referred to as the width of the tape, and an average perpendicular distance, hereinafter referred to as the thickness of the tape. The thickness of the tape is herein understood as the distance between two opposite points on the perimeter of the cross section, said two opposite points being chosen such that the distance between them is perpendicular on said width of the tape. Both the width and the thickness of the tape can be measured for example from pictures taken with an optical or electronic microscope. The width of the flat tape is preferably between 1 mm and 600 mm, more preferable between 1.5 mm and 400 mm, even more preferably between 2 mm and 300 mm, yet even more preferably between 5 mm and 200 mm and most preferably between 10 mm and 180 mm. Thickness of the flat tape preferably is between 10 μm and 200 μm and more preferably between 15 μm and 100 μm.

A preferred process for the formation of such tapes comprises feeding a polymeric powder between a combination of endless belts, compression-moulding the polymeric powder at a temperature below the melting point thereof and rolling the resultant compression-moulded polymer followed by drawing. Such a process is for instance described in EP 0 733 460 A2, which is incorporated herein by reference. If desired, prior to feeding and compression-moulding the polymer powder, the polymer powder may be mixed with a suitable liquid organic compound having a boiling point higher than the melting point of said polymer. Compression moulding may also be carried out by temporarily retaining the polymer powder between the endless belts while conveying them. This may for instance be done by providing pressing platens and/or rollers in connection with the endless belts. Preferably solid state drawable UHMWPE is used in this process. Examples of commercial available solid state drawable UHMWPE includes GUR 4150™, GUR 4120™, GUR 2122™, GUR 2126™ manufactured by Ticona; Mipelon XM 220™ and Mipelon XM 221U™ manufactured by Mitsui; and 1900™, HB312CM™, HB320CM™ manufactured by Montell.

The tensile strength of the fibers as measured according to ASTM D2256 is preferably at least 1.2 GPa, more preferably at least 2.5 GPa, most preferably at least 3.5 GPa. The tensile modulus of the fibers as measured according to ASTM D2256 is preferably at least 30 GPa, more preferably at least 50 GPa, most preferably at least 60 GPa. Best results in terms of 2D bending modulus were obtained when the fibers were UHMWPE fibers having a tensile strength of at least 2 GPa, more preferably at least 3 GPa and a tensile modulus of at least 40 GPa, more preferably of at least 60 GPa, most preferably at least 80 GPa.

The invention also relates to a method for manufacturing the compressed sheet of the invention comprising the steps of:
a) Providing at least one sheet comprising at least one woven or non-woven fabric, said fabric comprising polymeric fibers;
b) Using compressing means to apply a contact pressure of between 60 bar and 500 bar to said sheet;
c) Heating the sheet to an elevated temperature (T) with a heat up rate of between 3°/min and 200°/min while applying said contact pressure, said elevated temperature being below the peak temperature of melting (Tₘ) of said fibers, said Tₘ being determined by DSC under restrained conditions;
d) Keeping the sheet under the contact pressure and at the elevated temperature for a period of time of between 5 and 300 minutes;
e) Subsequently cooling down the sheet with a cooling rate of between 3°/min and 200°/min while maintaining the contact pressure and the elevated temperature; and
f) Releasing the compressing means not earlier than from the moment when the sheet reached a temperature of between 50° C. and 90° C.

The process of the invention may be carried out using conventional compressing means, e.g. any press able to reach a compression pressure of at least 500 bar and being suitable to be heated up to a set temperature of at least 400° C.

Such means are well known in the art and commercially available, examples thereof including presses sold by Burkle, Fontijne or Siempelkamp. 1 bar is approximately equal to 0.1 MPa.

In a preferred embodiment, the inventive sheet contains a single unfolded fabric, preferably the fabric being a woven fabric, having an initial thickness such that after carrying out the inventive process, a compressed sheet having the desired thickness is obtained. The skilled person can determine by routine experimentation the initial thickness of the fabric needed to yield the desired thickness of the compressed sheet. It was surprisingly found that a compressed sheet being lightweight while having a high resistance to buckling and/or bending can be obtained with the inventive process, even when said sheet only contained a single fabric. Furthermore it was observed that such a compressed sheet was not substantially affected by delamination when subjected to large bending and/or buckling deformations.

Preferably, the contact pressure applied at step b) of the process of the invention is between 80 and 450 bar; more preferably between 100 and 400 bar; even more preferably between 150 and 350 bar, most preferably between 250 and 350 bar. It was observed that for such high contact pressures the sheets of the invention showed an increased 2D bending modulus as well as a high flexural strength.

In a preferred embodiment, step b) of the inventive process is carried out in a press preheated at a preheat temperature of between 60 and 130° C., more preferably of between 80 and 120° C., most preferably between 85 and 110° C. Preferably, the sheet is kept in the preheated press at the preheat temperature for a period of time between 2 and 50 minutes, more preferably between 5 and 30 minutes, most preferably between 10 and 20 minutes before applying the contact pressure. Pressing equipment having preheating capabilities is long known in the art, e.g. those enumerated hereinabove. It was observed that for this embodiment, the inventive sheet may present in particular an increased homogeneity, i.e. irrespective of the place on sheet's surface where the measurement is carried out, of its mechanical properties and in particular of its 2D bending modulus.

In a further preferred embodiment, the temperature of the sheet before applying the contact pressure is between 30 and 100° C., more preferably of between 50 and 90° C., even more preferably between 70 and 85° C. The sheet can be heated in e.g. a conventional oven or by using infrared (IR) lamps and then immediately transferred to the pressing equipment. It was observed that for this embodiment, said homogeneity may be further improved but also the compression time at step e) of the inventive process needed to achieve high 2D bending modulus may be reduced.

According to the process of the invention, the sheet is heated up in step c) of the inventive process to an elevated temperature while applying a contact pressure thereof. The sheet is usually heated by heating the compressing means, e.g. the platens of a press, which in turn heat up said sheet. For some compressing means, a difference between the elevated temperature set on said means and the elevated temperature reached by the sheet may arise, said difference stemming from a poor heat transfer between said means and the sheet. The temperature of the sheet can be measured for example by a thermocouple placed on top or between the fabrics used to construct the inventive sheet. If such a difference arises the temperature of said means can be routinely adjusted such that the sheet is heated up at the elevated temperature required by the step c) of the inventive process.

According to the process of the invention the sheet is heated in step c) under the contact pressure up to an elevated temperature (T) below the peak temperature of melting (Tₘ) of said fibers, the Tₘ being determined by DSC under restrained conditions. It was observed that the Tₘ of the fibers may increase when the fibers are under restrained conditions, e.g. when the fibers are built into a fabric and the fabric is subjected to a contact pressure like in step c) of the process of the invention. Preferably the elevated temperature T satisfies the following conditions: Tₘ−30° C.<T<Tₘ; more preferably Tₘ−20° C.<T<Tₘ−3° C.; most preferably Tₘ−10° C.

<T<Tₘ−3° C. In the case when the polymeric fibers do not allow a precise determination with DSC of said peak temperature of melting (Tₘ), said Tₘ is considered as the temperature at which the fiber breaks when it is placed under a load equal to 2% of its normal tensile strength, said normal tensile strength being the strength measured according to ASTM D2256 at room temperature (20° C.).

It was observed that by carefully choosing the elevated temperature (T) and the contact pressure as well as the other parameters of the inventive process, the occurrence of a second polymeric phase with a low melting temperature due to secondary recrystallizations of the polymeric chains may be avoided. The presence or absence of such a second phase may be readily investigated e.g. by DSC measurements and in particular as detailed in GB 2,253,420. The inventors at least partly attributed the improvement in the mechanical properties of the inventive sheet to the absence of said second polymeric phase.

In a preferred embodiment, the fibers contained by at least one fabric of the sheet of the invention contain polyethylene fibers, more preferably UHMWPE fibers. More preferably the sheet contains fabrics comprising only polyethylene fibers, even more preferably only UHMWPE fibers. Preferably said fibers are tapes having the characteristics, e.g. width, thickness, cross-sectional aspect ratio, as detailed hereinabove. The sheet containing such a fabric is preferably heated in the process of the invention under a contact pressure of between 80 and 400 bar, more preferably between 100 and 350 bar, most preferably between 250 and 350 bar to an elevated temperature of between 125 and 158° C., more preferably between 125 and 157° C., most preferably of between 130 and 156° C. Even more preferably, the sheet is heated under a contact pressure of between 250 and 350 bars to a temperature of between 151 and 156° C. Most preferably, the sheet is heated under a contact pressure of between 250 and 350 bars to a temperature of between 154 and 156° C. The inventors observed during their experimental work that even small variations in the pressing temperature may influence the final mechanical properties of the sheet of the invention under certain conditions. It was observed that under the above mentioned processing conditions the 2D bending modulus of the sheet of the invention was even further increased. It was also observed that the occurrence of a second polymeric phase with a low melting temperature due to secondary recrystallizations of the polymeric chains was avoided.

Preferably the heat up and the cool down rates in steps c) and e) of the process of the invention are between 5°/min and 100°/min, more preferably between 5°/min and 50°/min, respectively. It was observed that by choosing such ramps a sheet having in particular an increased 2D bending modulus but also an increased homogeneity of said modulus may be obtained.

Preferably the sheet is kept under the contact pressure for a period of time of between 10 and 200 minutes; more preferably between 15 and 100 minutes; more preferably between 20 and 50 minutes. Required times will increase with increasing the thickness of the fabric or the number of fabrics used at step a) of the inventive process. It was observed that for said time periods the thickness variation of the inventive sheet may be reduced.

Good results were obtained when the sheet of step a) of the inventive process was kept at an elevated temperature under a contact pressure of between 150 and 350 bar for a period of time of between 20 and 50 minutes. Preferably, the sheet contained at least one fabric comprising UHMWPE fibers, more preferably, the fabric or the fabrics contained by said sheet are manufactured substantially entirely from UHMWPE fibers.

In a preferred embodiment of the inventive process, the sheet is kept under the contact pressure for a period of time of between 5 and 300 minutes during which period the elevated temperature T raises with a step-wise raising profile within the limits of preferably Tₘ−30° C.<T<Tₘ; more preferably Tₘ−20° C.<T<Tₘ−3° C.; most preferably Tₘ−10° C.<T<Tₘ−3° C. Preferably, said profile contains at least 1 raising step, more preferably at least 2 raising steps. Said profile may even contain at least 3 raising steps. Preferably, the elevated temperature is raised from one raising step to another with at most 10% per step, more preferably at most 5% per step, most preferably at most 3% per step. It was observed that surpassing or overshooting the set elevated temperature (T) was reduced and because of the more controlled manner of raising the temperature to reach said elevated temperature (T) the 2D bending modulus of a sheet obtained by a process according to this embodiment may be further increased. Furthermore, the inventive sheet showed an increased homogeneity of its mechanical properties. It was also observed that adhesive labels may adhere stronger to the inventive sheets obtained with the process of this embodiment.

In a further preferred embodiment, the fibers contained by at least one fabric of the sheet of the invention are polyethylene fibers, more preferably UHMWPE fibers, even more preferably said UHMWPE fibers being UHMWPE tapes and the fabric is preferably heated in step c) of the inventive process to an elevated temperature T between 133 and 158° C., more preferably of between 135 and 157° C., even more preferably between 137 and 146° C., most preferably between 153 and 156° C. and wherein at step d) of the inventive process the sheet is kept under the contact pressure for a period of time of between 5 and 300 minutes and wherein the elevated temperature T preferably rose during said period in a step-wise profile. Preferably, at said step d), said period of time was between 30 and 70 minutes.

Preferably the elevated temperature T rose with at least 10% per step in at least one step, more preferably rose with at most 3% per step in at least 2 steps. It was observed that under these processing conditions the 2D bending modulus of the sheet of the invention may even be further increased. The contact pressure is released at step e) of the inventive process not earlier than when the sheet is cooled down to between 50° C. and 90° C., preferably between 60° C. and 85° C., more preferably between 70° C. and 80° C. It was observed that by releasing the contact pressure at said temperatures, sheets with improved mechanical properties in multiple directions may be obtained.

The inventive process may further comprise a further lamination step wherein multiple sheets according to the invention are laminated together. The inventive process may also comprise a moulding step wherein the inventive sheet is imparted at least one curvature or it is imparted local areas that are raised or lowered with respect to the surrounding area. Such a moulding step can be carried out with conventional moulding equipment wherein the inventive sheet is compressed between two surfaces, at least one containing the features that are desired to be transferred to said sheet, e.g. local areas, curvatures in at least one directions, etc. Alternatively, the compression step b) in the inventive process can be carried out in such conventional moulding equipment.

The inventive sheets proved suitable for use as a construction material, in particular for constructing articles such as separation walls, liners, panels, protective panels against high winds of a hurricane category, containers, radomes, boxes, kits, roofs, tips, trolleys, carts and floors. The invention therefore relates to such construction materials and the mentioned articles comprising the sheet of the invention.

The invention also relates to a trailer adapted for towing behind an e.g. motor vehicle and in particular to a camping trailer, as for example that disclosed in U.S. Pat. No. 7,258,390, said trailer comprising the sheet and/or the panel of the invention. The invention also relates to a motor home, as for example that disclosed in U.S. Pat. No. 7,300,086, said motor home comprising the sheet and/or the panel of the invention. It was observed that such a trailer or motor home have good mechanical stability and impact resistance while being lightweight, reducing therefore the amount of fuel needed for their transportation.

In particular, the invention relates to a container comprising the inventive sheet. It was observed that the container of the invention shows improved dimensional stability and increased damage resistance. In particular it was observed that the walls of said containers are less affected by buckling or bulging when stored goods shift within the containers and exercise a pushing force on said walls from within. Also when said containers are stored in an open environment, accumulated precipitations on top of the container did not provoked excessive sagging of the top thereof. Therefore, the inventive container maintains a constant storage volume substantially independent of the manner in which they are utilized or stored.

It was also surprisingly observed that temporary adhesive labels, e.g. such as those usually used by logistic companies denoting the name of the owner, show an improved adhesion on the inventive sheet and thus on the container, requiring an increased force for peeling thereof. As a consequence, the containers of the invention can be stored for a longer period of time without the need of re-adhering such labels.

It was also surprisingly found that the containers of the invention showed an excellent perforation resistance against impact with forklift trucks and furthermore, a good resistance to UV degradation when stored for example in open spaces in direct sun light.

The container of the invention may be made from several panels that are joined together to form said container. The panels may be joined together by adhesives or fasteners such as rivets or nut/bolt assemblies.

The walls of the container may be curved or planar, preferably, the walls are planar. The container may therefore have different shapes, suitable examples including those disclosed for example in U.S. Pat. No. 6,991,124; U.S. Pat. No. 5,312,182; U.S. Pat. No. 5,180,190; U.S. Pat. No. 4,889,258 and U.S. Pat. No. 3,786,956 the disclosures thereof being fully included herein by reference.

In a particular embodiment, the container of the invention is a container for carrying luggage and other cargo during transport by aircraft which are commonly referred to as unit load devices (ULD). Within the airline industry it is a standard practice to compartmentalize the cargo by separating it into ULDs. The ULDs are shaped as boxes which can include appropriately sloped surfaces allowing the ULD to conform the to the aircraft's fuselage.

It was observed that by using the inventive sheet in constructing ULDs, it was possible to manufacture larger sized ULDs having increased dimensional stability and being lightweight. Furthermore, it was observed that said ULDs had an increased resistance to microorganisms adhering thereof, being therefore suitable to transport food products and the like.

Preferably, the inventive containers are made by connecting planar inventive panels to a frame, said frame being preferably made from a lightweight material and shaped with an edge profile. The frame is preferably made from lightweight composites reinforced with glass or carbon fibers, more preferably said frames are made from aluminum or magnesium or other lightweight metal. Such a construction not only proved to have high mechanical stability and impact resistance, but was also lightweight.

A common problem encountered with products that usually pass through customs and need to be scanned, e.g. boxes, containers and the like, is that said products usually need to be opened because they absorb the scanning radiation, usually X-rays, to a large extent, diminishing therefore the contrast of an obtained image of their interior. It was however observed that such products when containing the inventive sheet or panel are easier to e.g. X-ray because they hardly absorb any radiation when compared to products containing Aluminum sheeting which are highly opaque to such radiation. Therefore, for e.g. air-cargo containers where safety is of large concern, such radiation transparency is an advantage for better detection of weapons, explosives and other contraband materials stored therein.

The invention further relates to a system for protecting a building against high winds of a hurricane category, said system comprising a panel containing a strike face containing the sheet of the invention, said system also containing means, e.g. hooks, bolts, ropes, and the like, for securing said system in front of at least the parts of the building to be protected. By strike face is herein understood the face of the panel that is impacted first by debris carried by the winds. Preferably said strike face consists of the sheet of the invention.

The invention further relates to a dome comprising the sheet of the invention and a structural frame adapted for mounting said sheet thereunto. More in particular the invention relates to a radome, and more in particular to a geodesic radome, comprising the sheet of the invention, a frame adapted to mount said sheet thereunto and antenna elements mounted inside the radome. Radomes are known in the art for example from U.S. Pat. No. 5,182,155, known radomes having heavy composite wall structures reinforced with e.g. glass fibers. It was observed that the radome and in particular the geodesic radome of the invention are easier to be built and maintained than known radomes since lightweight sheets according to the invention are used for the construction thereof. Moreover, the radomes of the invention have a good structural stability resisting to winds, hale and snow depositing thereon.

### Measurement Methods

Cover factor: of a woven fabric is calculated by multiplying the average number of individual weaving yarns per centimeter in the warp and the weft direction with the square root of the linear density of the individual weaving yarns (in tex) and dividing by 10.

An individual weaving yarn may contain a single yarn as produced, or it may contain a plurality of yarns as produced which are assembled into the individual weaving yarn prior to the weaving process. In the latter case, the linear density of the individual weaving yarn is the sum of the linear densities of the as produced yarns. The cover factor (CF) can be thus computed according to formula:

$$CF = \frac{m}{10} \sqrt{p t} = \frac{m}{10} \sqrt{T}$$

wherein m is the average number of individual weaving yarns per centimeter, p is the number of as produced yarns assembled into a weaving yarn, t is the linear density of the yarn as produced (in tex) and T is the linear density of the individual weaving yarn (in tex).

AD: was determined by measuring the weight of a sample of preferably 0.4 m×0.4 m with an error of 0.1 g.

Intrinsic Viscosity (IV): for polyethylene is determined according to method PTC-179 (Hercules Inc. Rev. Apr. 29, 1982) at 135° C. in decalin, the dissolution time being 16 hours, with DBPC as anti-oxidant in an amount of 2 g/l solution, by extrapolating the viscosity as measured at different concentrations to zero concentration;

Tₘ: The representative sample used consisted of 10 mg of the fiber which was wound on a cylindrical aluminum spool having a diameter of 5 mm and a height of 2 mm. The ends of the fibers were fixated by knotting. A stress of about 0.05 N/tex was applied during winding.

The peak temperature of melting of the fiber under restrained conditions was determined by DSC on a power-compensation PerkinElmer DSC-7 instrument which is calibrated with indium and tin with a heating rate of 10° C./min. For calibration (two point temperature calibration) of the DSC-7 instrument about 5 mg of indium and about 5 mg of tin are used, both weighed in at least two decimal places. Indium is used for both temperature and heat flow calibration; tin is used for temperature calibration only.

The furnace block of the DSC-7 is cooled with water, with a temperature of 4° C. in order to provide a constant block temperature, for a stable baselines and good sample temperature stability. The temperature of the furnace block should be stable for at least one hour before the start of the first analysis. The representative sample is put into an aluminum DSC sample pan (50 μl), which is covered with an aluminum lid (round side up) and then sealed. In the sample pan (or in the lid) a small hole must be perforated to avoid pressure build-up (leading to pan deformation and therefore a worsening of the thermal contact).

The sample pan is placed in a calibrated DSC-7 instrument, said instrument also containing in the reference furnace a sample pan (also covered with a pierced lid and sealed) containing the aluminum spool without fibers.

A standard DSC temperature program is used dependant on the fibers to be analyzed. In case of UHMWPE fibers, the following temperature program is run:
1. sample is kept for 5 min at 40° C. (stabilization period)
2. increase temperature from 40 up to 200° C. with 10° C./min. (first heating curve)
3. sample is kept for 5 min at 200° C.
4. temperature is decreased from 200 down to 40° C. (cooling curve)
5. sample is kept for 5 min at 40° C.
6. optionally increase temperature from 40 up to 200° C. with 10° C./min to obtain a second heating curve.

The same temperature program is run with a pan containing an empty spool fitting in the sample side of the DSC furnace (empty pan measurement).

Analysis of the first heating curve is used as known in the art to determine the peak temperature of melting of the analyzed fiber. Furthermore, the heat of fusion ΔH may be obtained by integrating the peakarea, as is commonly known in the art. Furthermore the crystallinity of UHMWPE fibers may be calculated by dividing the ΔH by 293 J/g, which is the heat of fusion of a pure UHMWPE polymeric crystal.

The empty pan measurement is subtracted from the sample curve to correct for baseline curvature. Correction of the slope of the sample curve is performed by aligning the baseline at the flat part before and after the peaks (at 60 and 190° C. for UHMWPE). The peak height is the distance from the baseline to the top of the peak.

Peeling force: is the force (in grams) needed to pull off a sticker adhered to the surface of the sheet by pulling it along its length direction at an angle of 90° with respect to the surface of the sample. The sticker used was an “Avery Graphics 400 Permanent” 5×16 cm size sticker and was placed onto the surface of the sheet by pressing uniformly over the surface of said sticker with a force of about 5 Kg for about 1 minute.

Deflection: was measured with a 3-point bending test according to ISO 178 standard and quantified as the force needed to induce a 20 mm deflection in the testes sample. The test speed was 1 mm/min, the width of the sample was 25±0.5 mm, the width over thickness ratio was about 70, the radius of the loading edge was 5 mm and the radius of the supports was 2 mm. Impact energy: was measured according to formula below

Impact energy=m·g·h

by dropping from different heights (h) a hemispherical dart having a radius of 5 mm and a mass (m) of 4.93 Kg. g is the gravitational acceleration and equals 9.81 m/sec². 5 impacts were carried out for each sample and the results averaged. The height was increased until full penetration of the dart through the sample was achieved. The height at which full penetration was achieved was called Fall Height Stop. The impact energy is the energy required to induce a full penetration of the sample in 50% of the impacts.

### EXAMPLES AND COMPARATIVE EXPERIMENT

### Example 1

A sheet was assembled from 2 layers of a plain weave fabric constructed from UHMWPE fibers, said fibers being sold by DSM Dyneema under the name of Dyneema® SK 75 and having a titer of 1760 dtex. Each layer had an areal density of about 650 g/m², a cover factor of about 9.6 and a thickness before compaction of about 0.9 mm. No binder or matrix was used.

The layers were compressed in a steam heated Fontijne press at a contact pressure of 90 bar after which the temperature of the press was raised to a first temperature of 130° C. with a heat up rate of about 10° C./minute. The sheet was held under compression at said first temperature for 4 minutes after which the temperature of the press was raised again to a second temperature of 155° C. The temperature of the sheet at said second temperature of the press as measured by a standard thermocouple placed between the layers was about 152° C. The sheet was held to the second temperature for 30 minutes.

Subsequently, the sheet was cooled down to 20° C. with a cool down rate of about 20° C./minute, the press being released at a temperature of about 20° C.

The 2D bending modulus was measured in the orientation directions of the warp and the weft yarns.

### Example 2

Example 1 was repeated with the exception that 3 layers of a basket weave fabric were used instead of 2 layers of the plain weave fabric. Each layer of the basket weave fabric had an areal density of about 347 g/m², a cover factor of about 5.9 and a thickness before compaction of about 0.5 mm.

### Example 3

Example 1 was repeated with the exception that the contact pressure was 300 bar.

### Example 4

Example 2 was repeated with the exception that the layers of fabric were constructed from cross-plied monolayers, each monolayers containing unidirectionally aligned Dyneema® SK 75 held together by a polyurethane binder. The amount of binder in a monolayer was 20 wt %. The areal density of the fabric was 800 g/m².

The 2D bending modulus was measured in the orientation direction of the fibers in a monolayer and in the direction perpendicular thereof.

### Example 5

Example 1 was repeated with the exception that tapes were used instead of using Dyneema® SK 75 to construct the layers of fabric, said tapes being manufactured from UHMWPE and having a width of 50 mm, a thickness of 45 μm, a strength of 1.6 GPa and a modulus of 100 GPa. The tapes forming the wefts in a layer of fabric abutted each other with little overlap, i.e. less than 2 mm. The same holds true for the tapes forming the warps. The areal density of a layer was about 90 g/m². The contact pressure was 300 bar.

### Example 6

A sheet was assembled from 7 layers of a 557 twill weave fabric (5/1 twill) constructed from UHMWPE fibers, said fibers being sold by DSM Dyneema under the name of Dyneema® SK 75. Each layer had an areal density of about 263 g/m², a cover factor of about 9.92 and a thickness before compaction of about 0.9 mm. No binder or matrix was used.

The layers were preheated to a temperature of 80° C. for 10 minutes after which they were compressed in a steam heated Fontijne press at a contact pressure of 300 bar after which the temperature of the press was raised to 154° C. with a heat up rate of about 10° C./minute. The sheet was held under compression at said first temperature for 50 minutes. The temperature of the sheet at said second temperature of the press as measured by a standard thermocouple placed between the layers was about 155° C.

Subsequently, the sheet was cooled down to 20° C. with a cool down rate of about 15° C./minute, the press being released at a temperature of about 50° C.

The 2D bending modulus was measured in the orientation directions of the warp and the weft yarns.

### Examples 7

Example 6 was repeated with the exception the temperatures of the pressing was 158° C.

### Comparative Experiment A

Example 2 was repeated with the exception that the sheet was compressed at a pressure of 90 bar and at a temperature as measured with a thermocouple placed between the layers of fabric of 161° C.

### Comparative Experiment B

Example 2 was repeated with the exception that the sheet was compressed at a pressure of 25 bar and at a temperature as measured with a thermocouple placed between the layers of fabric of 152° C.

The results are presented in the table below:

| | Fall height | Impact | 2D Bending | Flexural | Peel |
|---|---|---|---|---|---|
| | stop | Energy | modulus | strength | force |
| Ex. | (cm) | (J) | (GPa) | (MPa) | (g) |
| 1 | 124 | 59.97 | 15.07 | | 230 |
| 2 | 109 | 52.72 | 31.67 | 42.0 | 490 |
| 3 | | | 30.92 | | |
| 4 | 130 | 60.03 | 18.04 | | |
| 5 | 75 | 36.3 | 40.01 | 109.7 | 195 |
| 6 | | | 25.36 | 102.3 | |
| 7 | | | 24.54 | 95 | |
| C. Exp. A | 20 | 8.5 | 8.51 | | 100 |
| C. Exp. B | 50 | 21.2 | 13.08 | | 150 |

1. A compressed sheet comprising at least one woven or non-woven fabric, said fabric comprising polymeric fibers, characterized in that the sheet has a bending modulus of at least 15 GPa when measured according to ASTM D790-07 in at least two directions and wherein one of said directions is the orientation direction of a first majority of the fibers contained by said at least one woven or non-woven fabric.

2. The sheet of claim 1 wherein the sheet is planar and the directions along which the bending modulus is measured are contained in the plane of the sheet.

3. The sheet of claim 1 wherein the sheet contains one fabric, preferably one woven fabric.

4. The sheet of claim 1 wherein the orientation direction of a first majority of the fibers is the common orientation direction of at least 10 mass % if the fibers contained by said fabric.

5. The sheet of claim 1 wherein the fabric is substantially matrix-free.

6. The sheet of claim 1 wherein the length L and/or the width W of the sheet are at least 0.5 meters.

7. The sheet of claim 1 wherein the fabric is a woven fabric containing gel spun ultrahigh molecular weight polyethylene (UHMWPE) fibers.

8. Method for manufacturing a compacted sheet having a bending stiffness of at least 10 GPa, said process comprising the steps of:
a. Providing at least one sheet comprising at least one woven or non-woven fabric, said fabric comprising polymeric fibers;
b. Using compressing means to apply a contact pressure of between 60 bar (6 MPa) and 500 bar (50 MPa) to said sheet;
c. Heating the sheet to an elevated temperature (T) with a heat up rate of between 3°/min and 200°/min while applying said contact pressure, said elevated temperature being below the peak temperature of melting (Tₘ) of said fibers as determined by DSC under restrained conditions;
d. Keeping the sheet under the contact pressure and at the elevated temperature for a period of time of between 5 and 300 minutes;
e. Subsequently cooling down the sheet with a cooling rate of between 3°/min and 200°/min while maintaining the contact pressure and the elevated temperature; and
f. Releasing the compressing means not earlier than from the moment when the sheet reached a temperature of between 50° C. and 90° C.

9. The method of claim 8 wherein at step b. the sheet is compacted at a pressure of between 150 MPa and 350 MPa.

10. The method of claim 8 wherein the sheet is kept under the contact pressure for a period of time of between 5 and 300 minutes during which period the elevated temperature T raises with a step a step-wise raising profile with the limits of Tₘ−30° C.<T<Tₘ.

11. The method of claim 8 wherein the fibers are UHMWPE fibers and the sheet is heated under a contact pressure of between 150 and 350 bar to an elevated temperature of between 145 and 148° C.

12. An article comprising the sheet of claim 1 wherein the article is chosen from the group consisting of separation walls, liners, radomes, geodesic radomes, panels, containers, boxes, kits, roofs, tips, trolleys, carts and floors.

13. A trailer, preferably a camping trailer, comprising the sheet of claim 1.

14. A container, in particular a unit load device, comprising the sheet of claim 1.

15. A radome, in particular a geodesic radome, comprising the sheet according to claim 1, a frame adapted to mount said sheet thereunto and antenna elements mounted inside the radome.
